(19) United States
(12) Patent Application Publication
(10) Pub. No.: US 2008/0115677 A1
(43) Pub. Date: May 22, 2008

(54) Food processor with combined grinding and juice extracting functions

(76) Inventors: Rong-Yuan Tseng, Taoyuan Hsien (TW); Jhih-Chang Yang, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/600,049

(22) Filed: Nov. 16, 2006

(51) Int. Cl. A23N 1/02; B07B 13/14; B30B 9/02; A23N 1/00

(52) U.S. Cl. 99/510; 241/92; 99/508; 100/213

(57) ABSTRACT

A food processor designed for grinding beans and cereals as well as extracting juice from fruits and vegetables includes a bowl, a base, a strainer basket, a cover, an upper grinding disc fixedly mounted around a bottom of a feed tube formed on the cover, and a lower grinding disc firmly connected to and driven by a driving mechanism on the base to rotate at high speed. Since the lower grinding disc is provided at a central area with differently shaped central blades and along a circumferential edge with multiple grinding teeth, the feed tube is offset from but overlaps a center of the lower grinding disc, and the upper grinding disc is provided with grinding teeth corresponding to the lower grinding disc, an expanded grinding area is available on and between the two grinding discs, and any dead area of grinding may be eliminated.

### FIELD OF THE INVENTION

The present invention relates to a food processor designed to grind beans and cereals as well as extract juice from fruits and vegetables, and more particularly to a food processor that has effectively increased grinding area and eliminates any dead area of grinding.

### BACKGROUND OF THE INVENTION

A conventional fruit and vegetable juice extractor (or briefly referred to as a juicer) usually includes only one lower grinding disc for cutting fruit and vegetable to extract juice therefrom. The lower grinding disc has a center forming a dead area that does not provide the cutting, grinding, and juice extracting functions. To overcome this problem, the conventional juicer adopts a feed tube offset from the center of the lower grinding disc, so that foodstuffs such as fruits or vegetables fed via the offset feed tube do not enter the dead area of grinding. This inevitably limits the available grinding area on the lower grinding disc to be smaller than a radius of the lower grinding disc. Moreover, with the offset feed tube, the conventional juicer fails to provide the function of grinding beans and cereals.

FIGS. 1A and 1B show a conventional food processor adapted to grind beans and cereals as well as extract juice from fruits and vegetables. As shown, the conventional food processor includes a bowl 11, a base 12, a strainer basket 13, a cover 14, and a lower and an upper grinding disc 15, 151. The base 12 is provided on a top with a driving mechanism 121, to which the lower grinding disc 15 is firmly connected. The cover 14 is provided with an offset feed tube 141, around a bottom of which the upper grinding disc 151 is fixedly mounted. When the cover 14 is closed onto the bowl 11, foodstuffs such as fruits and vegetables may be fed via the feed tube 141. A plunger 16 having teeth 161 formed on a bottom thereof is used to push the fed foodstuffs deep into the feed tube 141, so that the foodstuffs are ground and juice is extracted between the upper grinding disc 151 and the lower grinding disc 15, which is driven by the driving mechanism 121 to rotate at high speed. In the above-described conventional food processor, the lower grinding disc 15 still has a central area forming a dead area of grinding. Therefore, the feed tube 141 is so located that it is not only offset but also completely separate from the centered dead area of grinding on the lower grinding disc 15. Under this condition, only a limited annular area on the lower grinding disc 15 having a width smaller than a radius of the disc 15 is available for grinding. It is impossible to feed fruits or vegetables having a large overall volume, such as a whole piece of apple, pear, etc., into the conventional food processor for cutting, grinding, and extracting juice. That is, fruits such as apple, pear, etc. must be cut into small pieces before being fed via the feed tube 141 for grinding and extracting juice. On the other hand, to enable a food processor to directly process the whole piece of a large-size fruit or vegetable, the grinding discs thereof must have increased radius to increase the available grinding area. Under this circumstance, the food processor with the large grinding disc would have an extremely big volume. The big food processor is not convenient for operation and could not be economically produced.

It is therefore tried by the inventor to develop an improved food processor that provides combined functions of grinding beans and cereals as well as extracting juice from fruits and vegetables, and eliminate the central dead area of grinding to enhance the grinding and juice extracting effects.

### SUMMARY OF THE INVENTION

A primary object of the present invention is to provide a food processor particularly designed to grind beans and cereals as well as extract juice from fruits and vegetables.

Another object of the present invention is to provide a food processor that has effectively increased grinding area and eliminates any dead area of grinding.

A further object of the present invention is to provide a food processor that includes upper and lower grinding discs provided along circumferential edges with grinding teeth to provide enhanced grinding and juice extracting effects.

To achieve the above and other objects, the food processor according to the present invention includes a bowl, a base, a strainer basket, a cover, an upper grinding disc fixedly mounted around a bottom of a feed tube formed on the cover, and a lower grinding disc firmly connected to and driven by a driving mechanism on the base to rotate at high speed. Foodstuffs such as fruits and vegetables are fed via the feed tube to be cut and ground between the fixed upper grinding disc and the quickly rotating lower grinding disc. The lower grinding disc is provided within a central area with a plurality of differently shaped central blades, and along an outmost circumferential edge with a plurality of annularly arranged grinding teeth. The feed tube is offset from but overlaps a central area of the lower grinding disc. The upper grinding disc is provided along a circumferential edge with grinding teeth corresponding to the lower grinding disc. With the offset feed tube, the central blades, and the annularly arranged grinding teeth, an expanded grinding area is available on and between the two grinding discs, and a dead area of grinding at a central area of the lower grinding disc as would happen in the conventional food processor is now eliminated.

The grinding teeth annularly arranged on the upper and the lower grinding disc are particularly suitable for grinding beans and cereals, and are effective in enhancing the juice extracting effect. The upper grinding disc is fixedly mounted around the bottom of the feed tube via a mounting hole, which is accordingly offset from but overlaps the central area of the lower grinding disc to enable an expanded grinding area on the lower grinding disc.

In an embodiment of the present invention, the central blades on the lower grinding disc are located in the vicinity of a central area of the lower grinding disc.

In another embodiment, the central blades on the lower grinding disc are located within a central area of the lower grinding disc.

In a further embodiment, the central blades on the lower grinding disc are located across a central area of the lower grinding disc.

The central blades may be otherwise formed from a plurality of triangle-sectioned and pointed cutting bodies arranged in two rows directed toward two opposite directions.

Alternatively, the central blades may be otherwise formed from a plurality of shuttle-shaped cutting bodies arranged within the central area of the lower grinding disc in a predetermined pattern. Each of the shuttle-shaped bodies has two pointed ends, and one of the two ends is raised from a top of the central area of the lower grinding disc.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is an exploded perspective view of a conventional food processor for grinding and extracting juice from foodstuffs;

FIG. 1B is a cutaway view of the conventional food processor of FIG. 1A in an assembled state;

FIG. 2A is an exploded perspective view of a food processor according to a preferred embodiment of the present invention;

FIG. 2B is a bottom view of a plunger 16;

FIG. 3 is a cutaway view of the food processor of FIG. 2A in an assembled state;

FIG. 4A is a perspective top view of a lower grinding disc used in the food processor of the present invention;

FIG. 4B is an enlarged view of the central blades provided in a central area of the lower grinding disc of FIG. 4A;

FIG. 5 is a perspective top view of another embodiment of the lower grinding disc used in the present invention; and

FIG. 6 is a perspective top view of a further embodiment of the lower grinding disc used in the present invention.

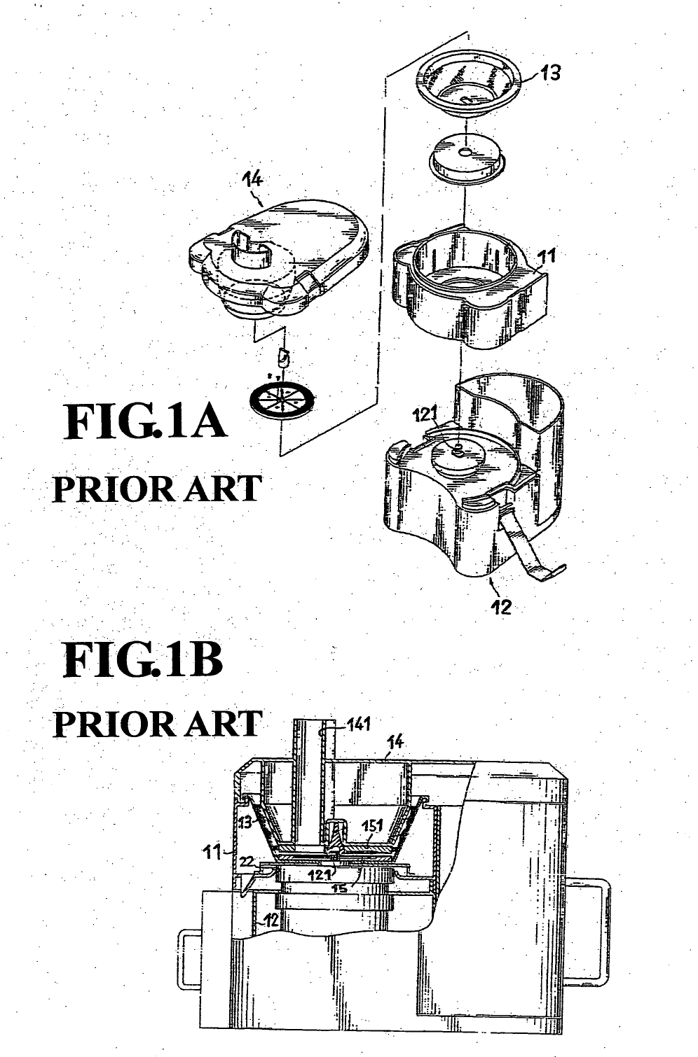

### DETAILED DESCRIPTION OF THE PREFERRED EMBODIMENTS

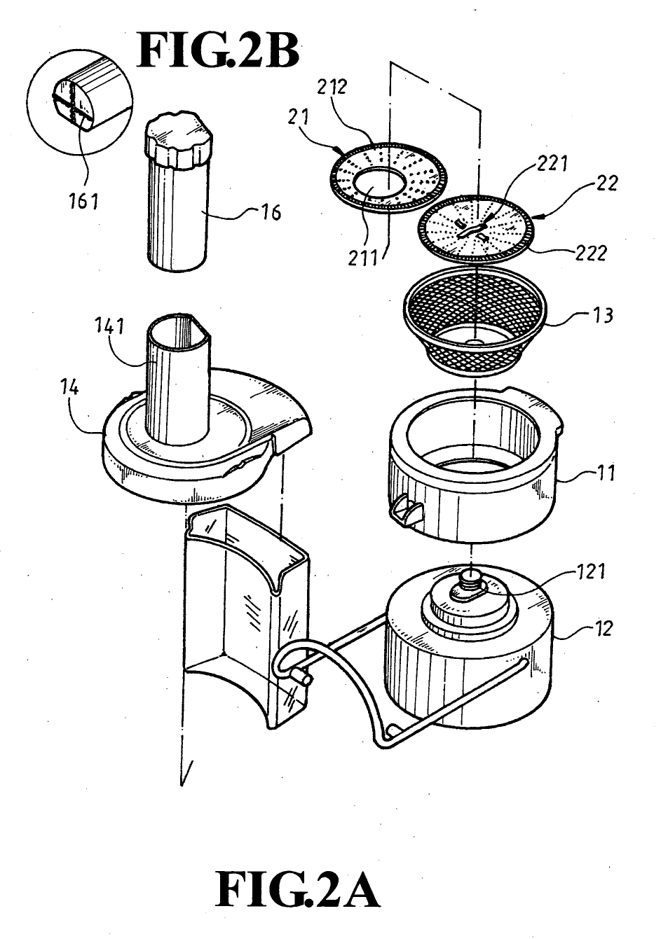

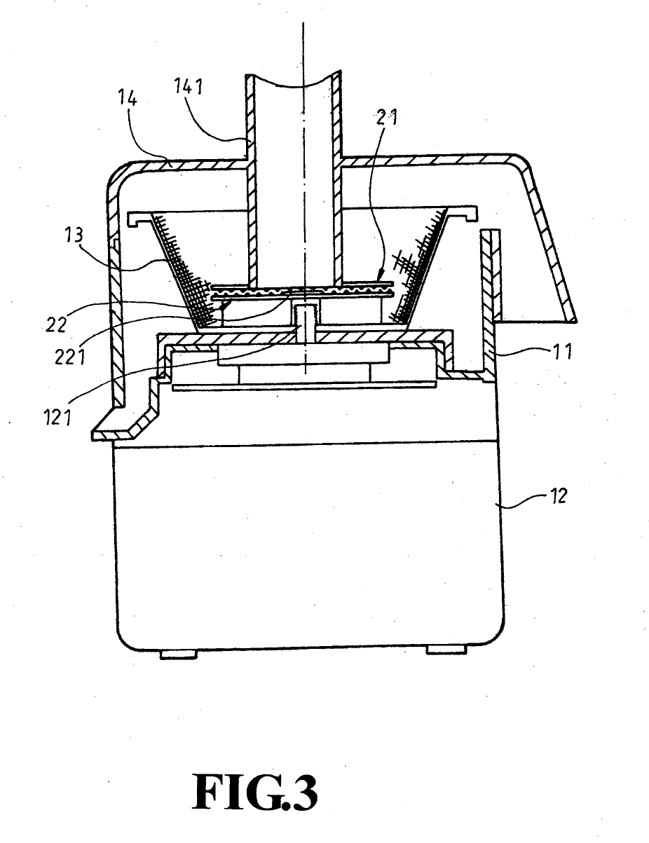

Please refer to FIGS. 2A and 3 at the same time. A food processor according to a preferred embodiment of the present invention includes a bowl 11, a base 12, a strainer basket 13, a cover 14, an upper grinding disc 21, and a lower grinding disc 22. The base 12 is provided on a top with a driving mechanism 121, to which the lower grinding disc 22 is firmly connected. The upper grinding disc 21 is fixedly mounted to and around a bottom of a feed tube 141 formed on the cover 14. The feed tube 141 is offset from but overlaps a center of the lower grinding disc 22. The lower grinding disc 22 is provided on or around the center thereof with a plurality of differently shaped central blades 221, and along a full length of an outmost circumferential edge with a plurality of annularly arranged grinding teeth 222. The upper grinding disc 21 is provided at a position corresponding to the feed tube 141 with a mounting hole 211, and along a full length of an outmost circumferential edge thereof with a plurality of annularly arranged grinding teeth 212 corresponding to the grinding teeth 222. The mounting hole 211 is offset from a center of the upper grinding disc 21 but overlaps the center of the lower grinding disc 22.

The food processor assembled from the above described parts is adapted to grind beans and cereals, and extract juice from fruits and vegetables. When foodstuffs, such as beans and/or cereals, or fruits and/or vegetables, are fed via the offset feed tube 141, and the lower grinding disc 22 is driven by the driving mechanism 121 to rotate at high speed, the grinding teeth 222 on the lower grinding disc 22 cooperate with the grinding teeth 212 on the upper grinding disc 21 to grate and grind or to extract juice from the fed foodstuffs. Since the offset feed tube 141 still overlaps the center of the lower grinding disc 22, the food processor has an expanded processing area wider than a radius of the lower grinding disc 22 for extracting juice from relatively large pieces of fruits and/or vegetables. Meanwhile, with the central blades 221 on the lower grinding disc 22, an enlarged available grinding area and an enhanced grinding and juice extracting performance may be obtained in the food processor of the present invention, and the problem of having a dead area at the central area of the grinding disc without cutting and grinding function is eliminated.

Please refer to FIG. 3. When the food processor of the present invention is fully assembled, the feed tube 141 on the cover 14 is offset from but overlaps the central area of the lower grinding disc 22. When the lower grinding disc 22 is brought by the driving mechanism 121 to rotate at high speed, foodstuffs such as beans, cereals, fruits, and/or vegetables being fed via the feed tube 141 would fall on the lower grinding disc 22 at areas offset from the central area thereof and be ground completely. The problem of dead area of grinding does not exist in the food processor of the present invention at all. When the fed foodstuffs are centrifugally moved into a clearance between the upper and the lower grinding disc 21, 22, they are completely ground by the grinding teeth 212, 222 annularly arranged on the circumferential edges of the upper and the lower grinding disc 21, 22. Since the central blades 221 on the lower grinding disc 22 are either located in the vicinity of, within, or across the center of the lower grinding disc 22, and the feed tube 141 is offset from but overlaps the center and the central blades 221 of the lower grinding disc 22, foodstuffs fed via the feed tube 141 into the upper and the lower grinding disc 21, 22 may be fully cut and ground without the problem of falling into a dead area of grinding and not being ground. The grinding and juice extracting effect is therefore upgraded.

In the food processor of the present invention, since the central blades 221 on the lower grinding disc 22 are either located in the vicinity of, within, or across the center of the lower grinding disc 22, and the feed tube 141 is offset from but overlaps the center and the central blades 221 of the lower grinding disc 22, an expanded cutting and grinding area is available. With these arrangements, fruits such as apple, pear, etc. that have a considerably large volume may be directly fed via the feed tube 141 without the need of cutting into small pieces in advance. Therefore, the food processor of the present invention is more convenient for use. With the expanded grinding area, the fed foodstuffs may be completely ground or juiced, giving the food processor increased value in practical use thereof.

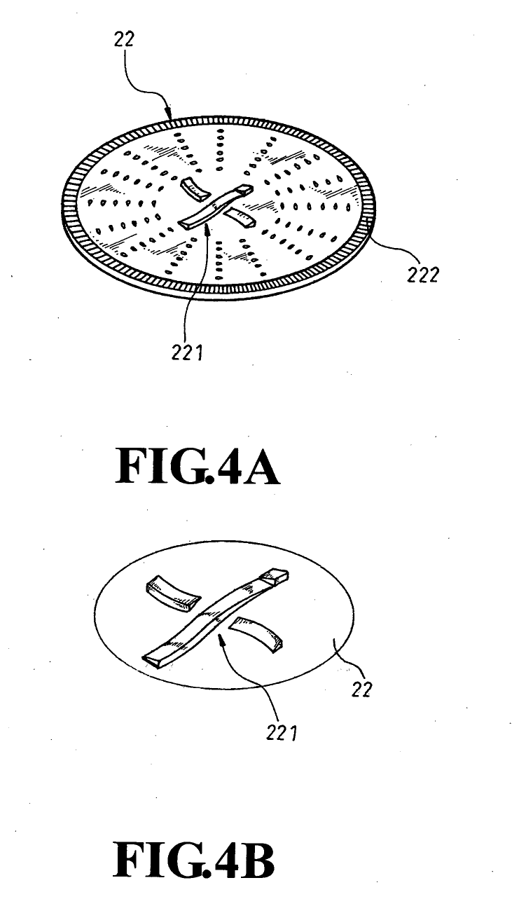

FIG. 4A is a perspective top view of the lower grinding disc 22 included in the present invention. As can be clearly seen from FIG. 4A, the central blades 221 are either located in the vicinity of, within, or across the center of the lower grinding disc 22, enabling cutting and grinding of foodstuffs at the central area of the lower grinding disc 22 to eliminate any dead area of grinding. FIG. 4B is an enlarged view of the central blades 221 shown in FIG. 4A.

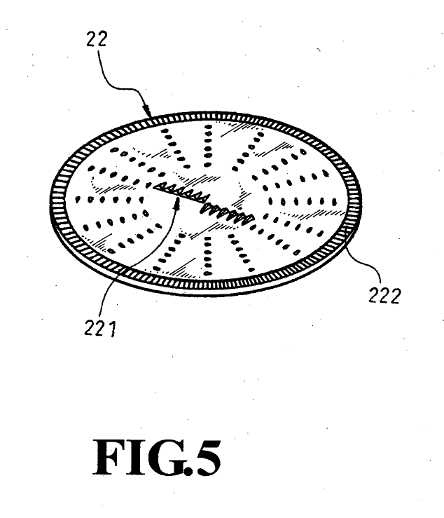

FIG. 5 shows another embodiment of the central blades 221 for the lower grinding disc 22. In this embodiment, the central blades 221 include a plurality of triangle-sectioned and pointed cutting bodies arranged in two rows directed toward two opposite directions.

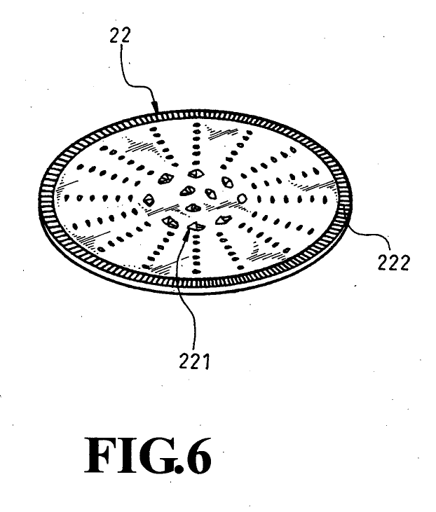

FIG. 6 shows a further embodiment of the central blades 221 for the lower grinding disc 22. In this embodiment, the central blades 221 include a plurality of shuttle-shaped cutting bodies arranged within the central area of the lower grinding disc 22 in a predetermined pattern; each of the shuttle-shaped bodies has two pointed ends, and one of the two ends is raised from a top of the central area of the lower grinding disc 22.

No matter what shapes the central blades 221 have, they are always located in the vicinity of, within, or across the center of the lower grinding disc 22. The central blades 221 together with the offset feed tube 141, which still overlaps the center of the lower grinding disc 22, enable the forming of a quite large grinding area on and between the grinding discs 21, 22 to thoroughly cut, grind, or extract juice from all the foodstuffs fed into the food processor.

In brief, with the offset feed tube 141, the upper grinding disc 21, and the lower grinding disc 22 with central blades 221, the food processor of the present invention does not have any dead area of grinding while providing an expanded grinding area to largely enhance the grinding and juice extracting effects thereof.

1. A food processor designed for grinding beans and cereals as well as extracting juice from fruits and vegetables, comprising: a bowl, a base, a strainer basket, a cover, a lower grinding disc having a central axis, an upper grinding disc having a central axis, and said lower grinding disc spaced from said upper grinding disc; said base being provided on a top with a driving mechanism, to which said lower grinding disc is firmly connected, to be driven by said driving mechanism to rotate at high speed relative to said upper grinding disc; said upper grinding disc being fixedly mounted around a bottom of a feed tube formed on said cover; such that foodstuffs such as fruits and vegetables may be fed via said feed tube to be cut and ground between said fixed upper grinding disc;
wherein said lower grinding disc is provided at a top central area with a plurality of differently shaped central blades protruding upward therefrom, and along a full length of an outmost circumferential edge with a plurality of annularly arranged grinding teeth, said feed tube being offset from but overlapping a center of said lower grinding disc, and said upper grinding disc being provided at a position corresponding to said feed tube with a mounting hole formed through said upper grinding disc, said mounting hole being offset from said central axis of said upper grinding disc and overlapping the central axis of said lower grinding disc, and along a full length of an outmost circumferential edge with a plurality of grinding teeth;
whereby an expanded cutting and grinding area is defined on said lower grinding disc, without a dead area of grinding at the center of said lower grinding disc.

2. The food processor as claimed in claim 1, wherein said central blades on said lower grinding disc are selectively located in the vicinity of, within, or across the center of said lower grinding disc.

3. The food processor as claimed in claim 1, wherein said central blades on said lower grinding disc include a plurality of triangle-sectioned and pointed cutting bodies arranged in two rows directed toward two opposite directions.

4. The food processor as claimed in claim 1, wherein said central blades on said lower grinding disc include a plurality of shuttle-shaped cutting bodies arranged within the central area of said lower grinding disc in a predetermined pattern; each of said shuttle-shaped bodies having two pointed ends, and one of the two ends being raised from a top of the central area of said lower grinding disc.
